(19) United States
(12) Patent Application Publication
(10) Pub. No.: US 2010/0181838 A1
(43) Pub. Date: Jul. 22, 2010

(54) Roof Power Generator

(76) Inventor: Wayne Farris, Hickory Creek, TX (US)

Correspondence Address: WILSON DANIEL SWAYZE, JR., 3804 CLEARWATER CT., PLANO, TX, 75025, US

(21) Appl. No.: 12/356,132

(22) Filed: Jan. 20, 2009

(51) Int. Cl. H02J 3/38; F03D 9/02

(52) U.S. Cl. 307/72; 290/55

(57) ABSTRACT

A device to generate electricity for building may include a rotating heat electric generating device including turbine blades to rotate in response to heat escaping an attic of the building, a DC/AC power inverter to convert the energy generated by the rotating turbine blades into electricity energy, a storage battery device to store the electrical energy, a switch device to receive the electrical energy from the storage battery device and to switch between a electric bus of the building or a utility service provider, and a controller to control the storage battery device and the switch device so the storage battery device selectively charges and discharges the electric power and so the switch device switches between the building and the utility service provider. The DC/AC power inverter may convert the DC power from the storage battery device to AC power for the splitter switch device, and the apparatus may include a solar electric generating device to generate electric power from the sun's rays. The solar generating electric device may be connected to an electric motor, and the solar generating electric device may be connected to the storage battery device.

### FIELD OF THE INVENTION

The present invention relates to generators and more particularly to a thermal generator to generate electrical power from heat. In addition, generators can be driven by wind from the turbines or a spinning vent. The generators can also be driven by an electric motor that is powered from a solar panel.

### BACKGROUND OF THE INVENTION

Over the last several years, the price of electricity for both homes and businesses has risen steadily. Most electricity is generated as result of the burning of fossil fuels in order to power turbines which in turn are used to generate electricity. The electric generating stations are typically not located near metropolitan areas. Consequently this electricity may be required to be transmitted over long distances in order to reach the consumers of the electricity. Many people are recognizing the hazards to the environment as a result of the pollution resulting from the burning of the fossil fuels.

Consequently, it would be desirable to find a way of generating electricity that would eliminate the need to burn fossil fuels. It would be advantageous if the cost of generating electricity could be reduced and if the generation of electricity was generated from renewable resources in order to eliminate the depletion of the resources of the planet. Some people have advocated the use of wind power in order to reduce the price of electricity. The solution is advantageous; however, the solution may require a high tower in order to reach a position where the wind blows freely. Furthermore, not all the localities have sufficient wind in order to power a turbine. One of the biggest needs for electricity especially during summer time is the need to generate electricity for air conditioning. Logically, the need for air conditioning is greatest when and where the temperature is relatively high. In southern climates, this need is especially significant during the summer months.

Generally during the summer months, a significant amount of heat is generated and stored within the attic space of most homes and businesses. Insulation may be provided in order to keep the heat in the attic space from entering the living space of homes or businesses. Homeowners and businesses may employ electric fans or wind driven (turbines) fans in order to remove this heat from the attic. It would be desirable to have the capability of transforming this heat in the attic space into usable electricity.

### SUMMARY

A device to generate electricity for building may include a rotating heat electric generating device including turbine blades to rotate in response to heat escaping an attic of the building, a DC/AC power inverter to convert the energy generated by the rotating turbine blades into electricity energy, a storage battery device to store the electrical energy, a switch device to receive the electrical energy from the storage battery device and to switch between a electric bus of the building or a utility service provider, and a controller to control the storage battery device and the switch device so the storage battery device selectively charges and discharges the electric power and so the switch device switches between the building and the utility service provider.

The DC/AC power inverter may convert the DC power from the storage battery device to AC power for the splitter switch device, and the apparatus may include a solar electric generating device to generate electric power from the sun's rays.

The solar generating electric device may be connected to an electric motor, and the solar generating electric device may be connected to the storage battery device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a power generation system in accordance with the present invention.

### DETAILED DESCRIPTION

The present invention includes a system 100 and an apparatus for generating electricity based upon the heat which is typically generated within the attic space of a home or business. The heat may drive precision rotating vents which drive precision generators to produce DC or AC power by employing a DC battery storage/inverter (to change DC power to usable AC power) or employing an AC generator that may generate electricity that can be used directly into the electrical bus of the building, voltage regulator and controller switches. The building may be a home or a business or any building with an attic. The generation of electricity in this manner may save the consumers and businessmen large amounts of money that would otherwise be paid to the local utility. Furthermore, since the electricity is locally generated, there is no need for long transmission lines and the associated costs of building and maintaining a transmission system. The present invention does not rely solely on wind power and may reduce global warming. These types of systems would provide additional security and comfort to our nation and provide electricity at a significantly lower cost. It is generally known that heat rises and cool air falls. Consequently, the present invention advantageously takes advantage of this phenomenon in order to generate electricity. The present invention employs a rotary heat vent which may include fins or blades which rotate about a central shaft.

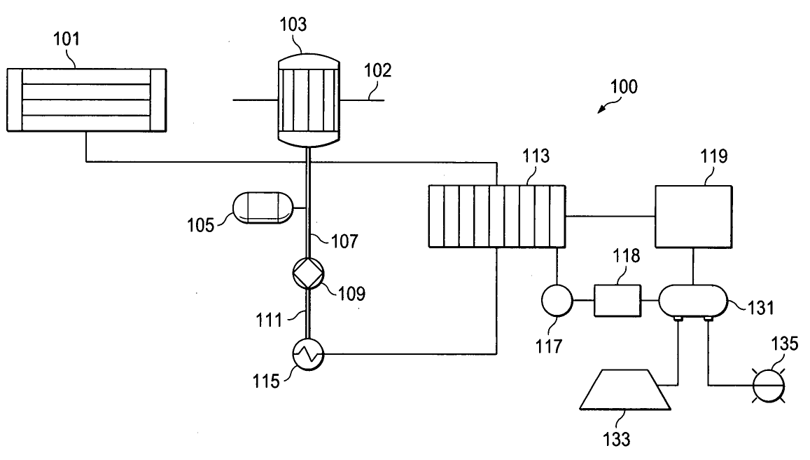

FIG. 1 illustrates the electric generating system 100 which may include a rotary heat electric generating device 103 which may include a turbine which may include turbine blades which may rotate on a shaft. The rotary heat electric generating device 103 may be mounted on a building roof 102, in an attic, which may be for a commercial, residential, unoccupied or any other building. The extreme temperatures found in the attic rises and escapes passed the turbine blades which cause the blades and shaft to rotate. The shaft of the rotary heat electric generating device 103 may be a first shaft 107 to connect the rotary heat electric generating device 103 to a transmission device 109 which may include multiple gears to adjust the speed of the second driveshaft 111 in accordance with the speed of the first driveshaft 107. The turning of the first driveshaft 107 results in the transmission device 109 turning the second driveshaft 111, and the speed of the second driveshaft 111 is controlled by the transmission device 109. The second driveshaft 111 is connected to an electromagnetic generator which may be an electric motor device 115 which converts the energy received by the rotation of the second driveshaft 111 which corresponds to the energy of the rotary heat electric generating device 103 to electrical energy which is connected to the storage battery device 113 by a wire so that the electrical energy is stored in the storage battery device 113. FIG. 1 additionally illustrates a controller 117 which controls the storage of the energy in the battery storage device 113 and may also control the discharge of energy from the storage battery device 113 to the DC/AC power inverter through an appropriate voltage regulator 118 which converts the DC power stored in the storage battery device 113 to AC power through the voltage regulator 118. The AC power may be suitable for household use or suitable to be returned to the power grid for use by others. The AC power which may be output by the storage battery device 113 is input to the splitter switch device 131 over a wire and the splitter switch device 131 may divert or switch the AC power to selected devices to use or consume the AC power. The splitter control switch 131 may be controlled by the controller 117 in order to determine the selected device to receive the AC power. The controller 117 may control the splitter switch device 131 to deliver the AC power to the house/business electric bus 133 or the controller 117 may control the splitter switch device 131 to deliver the AC power to the utility service provider 135.

Alternatively, the system 100 may include a solar electric generating device 101 which may generate electricity and which may be connected to an electric motor 105 by a wire. The electric motor may rotate the first driveshaft 107 to generate electricity which may be stored in the storage battery device 113 as described herein above. Alternatively, the solar electric generating device 100 may generate electricity and transmit that electricity to the storage battery device 113 by a wire which may store the electricity as described above. A turbine that is driven by the wind, for example by a spinning vent, can also generate electricity for the present invention. The spinning vent may be positioned close to the crest of the roof.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A device to generate electricity for building, comprising:
a rotating heat electric generating device including turbine blades to rotate in response to heat escaping an attic of the building;
a DC/AC power inverter to convert the energy generated by the rotating turbine blades into electricity energy;
a storage battery device to store the electrical energy;
a switch device to receive the electrical energy from the storage battery device and to switch between a electric bus of the building or a utility service provider; and
a controller to control the storage battery device and the switch device so the storage battery device selectively charges and discharges the electric power and so the switch device switches between the building and the utility service provider.

2. A device to generate electricity for building as in claim 1, wherein the DC/AC power inverter converts the DC power from the storage battery device to AC power for the splitter switch device.

3. A device to generate electricity for building as in claim 1, wherein the apparatus includes a solar electric generating device to generate electric power from the sun's rays.

4. A device to generate electricity for building as in claim 2, wherein the solar generating electric device is connected to an electric motor.

5. A device to generate electricity for building as in claim 2, wherein the solar generating electric device is connected to the storage battery device.

6. A device to generate electricity for the building as in claim 2, wherein the device includes a spinning or rotating turbine being positioned close to the crest of the roof to be powered by the wind.
